(19) United States
(12) Patent Application Publication
(10) Pub. No.: US 2025/0322178 A1
(43) Pub. Date: Oct. 16, 2025

(54) SYSTEM AND METHOD FOR PREVENTING HALLUCINATIONS

(71) Applicant: SRI International, Menlo Park, CA (US)

(72) Inventors: Michael COGSWELL, Yardley, PA (US); Ajay DIVAKARAN, Monmouth Junction, NJ (US); Karan SIKKA, Robbinsville, NJ (US); Yunye GONG, West Windsor, NJ (US)

(21) Appl. No.: 19/176,506

(22) Filed: Apr. 11, 2025

Related U.S. Application Data
(60) Provisional application No. 63/633,608, filed on Apr. 12, 2024.

(51) Int. Cl. G06F 40/40

(52) U.S. Cl. CPC G06F 40/40

(57) ABSTRACT

A method, apparatus and system for preventing hallucinations in a language model include monitoring a generation of a token by the language model, determining a measure of uncertainty for the generated token, comparing the determined measure of uncertainty with an expected measure of uncertainty, such as a predetermined threshold, generating at least one think token if the determined measure of uncertainty does not comply with the expected measure of uncertainty, and communicating the at least one generated think token to the language model to cause the language model to perform at least one additional computation for determining the token.

### CROSS-REFERENCE TO RELATED APPLICATION

This application claims benefit of and priority to U.S. Provisional Patent Application Ser. No. 63/633,608, filed Apr. 12, 2024, which is herein incorporated by reference in its entirety.

### FIELD

Embodiments of the present principles generally relate to improving the accuracy of language models and, more particularly, to a method, apparatus and system for preventing hallucinations in Language Model based systems by configuring language models to perform additional computations based on an uncertainty measure.

### BACKGROUND

Content understanding today consists of answering questions about the content with no regard to the difficulty of the questions or any other relationship between the questions. The state of the art consists of systems that use neural networks to memorize answers to questions. For example, Large Language Models (LLMs), such as ChatGPT, give good answers to many questions but often give wildly inaccurate answers to difficult/complex questions, often called hallucinations. Similarly, a Visual question answering (VQA) system, such as a visual language model (VLM), assumes the task of answering questions based on an image or video. The approaches to VQA are largely statistical, with no notion of relative difficulty of questions. Such visual systems also give inaccurate answers to difficult/complex questions, again often considered hallucinations.

For example, complex questions such as ‘how much is 45 times 39’, which are computationally taxing, are problematic for a language model to process or even answer correctly. Current solutions to addressing the inaccuracies of language models for answering difficult/complex questions include attempting to further train language models to memorize responses to difficult questions. Such training, however can be time consuming and very expensive, and it would be practically impossible to train a language model to memorize the answer to all difficult/complex questions.

### SUMMARY

Embodiments of the present principles provide methods, apparatuses and systems for preventing hallucinations in Language Model based systems by configuring language models to perform additional computations when facing a difficult/complex problem/question.

In some embodiments a method for preventing hallucinations in a language model include monitoring a generation of a token by the language model, determining a measure of uncertainty for the generated token, comparing the determined measure of uncertainty with an expected measure of uncertainty, such as a predetermined threshold, generating at least one think token if the determined measure of uncertainty does not comply with the expected measure of uncertainty, and communicating the at least one generated think token to the language model to cause the language model to perform at least one additional computation for determining the token.

In some embodiments an apparatus for preventing hallucinations in a language model includes a processor and a memory coupled to the processor, the memory having stored therein at least one of programs or instructions. In some embodiments, when the processor executes the programs or instructions, the apparatus is configured to monitor a generation of a token by the language model, determine a measure of uncertainty for the generated token, compare the determined measure of uncertainty with an expected measure of uncertainty, generate at least one think token if the determined measure of uncertainty does not comply with the expected measure of uncertainty, and communicate the generated at least one think token to the language model to cause the language model to perform at least one additional computation for determining the token.

In some embodiments a system for preventing hallucinations in a language model includes a language model and an apparatus including a processor and a memory coupled to the processor, the memory having stored therein at least one of programs or instructions. In some embodiments, when the processor executes the programs or instructions, the apparatus is configured to monitor a generation of a token by the language model, determine a measure of uncertainty for the generated token, compare the determined measure of uncertainty with an expected measure of uncertainty, generate at least one think token if the determined measure of uncertainty does not comply with the expected measure of uncertainty, and communicate the at least one generated think token to the language model to cause the language model to perform at least one additional computation for determining the token.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of a reasoning system in accordance with an embodiment of the present principles.

FIG. 2 depicts a graphical representation of a functionality of the reasoning system of the present principles in accordance with an embodiment of the present principles.

FIG. 3 depicts a flow diagram of a method for configuring a language model to perform greater computations when facing a complex problem in accordance with an embodiment of the present principles.

FIG. 4 depicts a computing device suitable for use with embodiments of a reasoning system in accordance with the present principles

FIG. 5 depicts a high-level block diagram of a network in which embodiments of a reasoning system in accordance with the present principles, can be applied.

FIG. 6A depicts a Table displaying the effects to the output of text content of an LLM in an experiment in which a reasoning system is applied in accordance with a least one embodiment of the present principles.

FIG. 6B depicts a Table displaying the effects to the output of image content of a VLM in an experiment in which a reasoning system is applied in accordance with a least one embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for preventing hallucinations in language models by configuring language models to perform additional computations when facing a difficult/complex question/problem. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific examples of uncertainty measures, such teachings should not be considered limiting. Embodiments in accordance with the present principles can function with substantially any process that can identify when a language model is unsure of an answer.

As used herein, the phrase “think token” is intended to depict a generated token that when implemented by a language model, such as a large language model (LLM), enables the language model to pause from a normal routine of generating tokens and perform at least one additional computation before generating responses; improving complex problem-solving.

Embodiments of the present principles are provided to configure language models, such as large language models (LLMs), to perform additional computations when facing a difficult/complex question/problem, termed “think before you speak”. That is, it could be considered that language models, such as LLMs, speak by predicting a next token (e.g., a portion of a word, a word, a phrase, a portion of an image, an image, a portion of a video, a video, and the like) in a sequence of tokens. What it would take for an LLM not to hallucinate is to think first (i.e., perform additional computations) before predicting a token, at least when the LLM is not sure of a next token to predict.

In some embodiments, to configure a language model to perform additional computations when facing a difficult/complex question/problem, a generation of a token by the language model is monitored, a measure of uncertainty for the generated token is determined, the determined measure of uncertainty is compared with an expected/desired probability (e.g., entropy) for the determination of a word/token which can be represented by a predetermined threshold, a think token is generated if the determined measure of uncertainty does not comply with the expected/desired probability (e.g., the predetermined threshold), and the generated think token is communicated to the language model to cause the language model to perform at least one additional computation for determining the token.

In some embodiments, during training of a model, such as an LLM, the generation of tokens is monitored and a respective measure of uncertainty is determined for the generation of each token. If a respective determined measure of uncertainty does not comply with a standard (e.g., a predetermined threshold), a think token is generated for the LLM, such that whenever content consistent with the token for which a think token was generated is processed by the LLM, at least one additional computation is performed for attempting to generate a token associated with that content. That is, in such embodiments, an LLM is trained to use think tokens whenever processing a difficult/complex question/problem, which results in a measure of uncertainty that does not comply with a standard (e.g., a predetermined threshold).

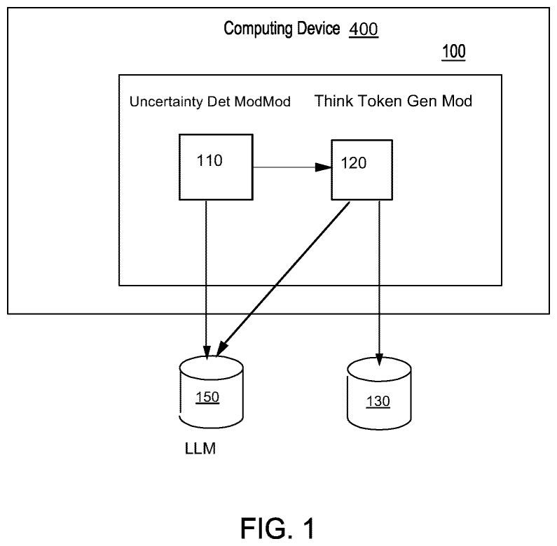

FIG. 1 depicts a high-level block diagram of a reasoning system 100 in accordance with an embodiment of the present principles. The reasoning system 100 of FIG. 1 illustratively comprises an uncertainty determination module 110, a think token generation module 120, and an optional storage device 130. FIG. 1 further depicts a language model, illustratively a Large Language Model (LLM) 150. Although in the embodiment of FIG. 1, the language model 150 is illustratively an LLM, in alternate embodiments, a reasoning system of the present principles can be applied to other language models, such as a visual language model (VLM) and the like.

As further depicted in FIG. 1, embodiments of a reasoning system of the present principles, such as the reasoning system 100 of FIG. 1, can be implemented via a computing device 400 in accordance with the present principles (described in greater detail below).

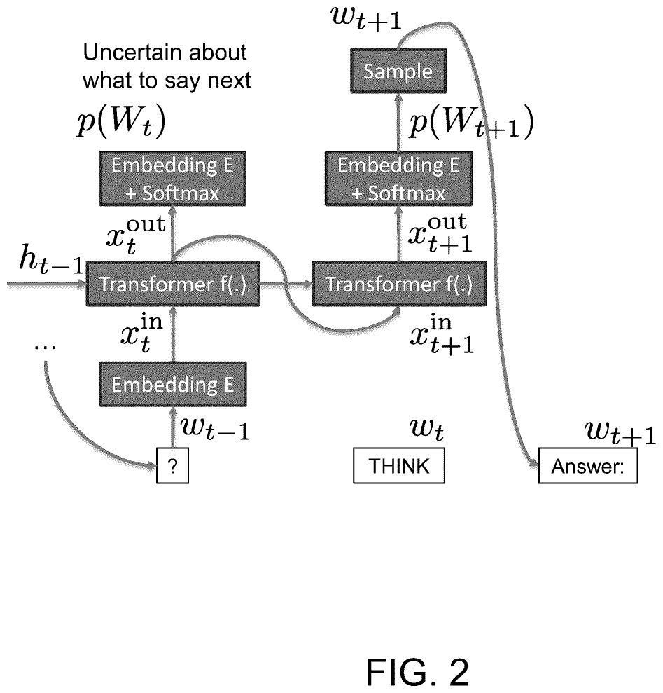

FIG. 2 depicts a graphical representation of a functionality of the reasoning system of the present principles, such as the reasoning system 100 of FIG. 1, upon the operation of an LLM, such as the LLM 150 of FIG. 1, in accordance with at least one embodiment of the present principles. The embodiment of FIG. 2 illustratively depicts an operation of the LLM 150 during the generation of a token/word, illustratively word, [symbol] ₜ. In the embodiment of FIG. 2, an embedding vector,

$${x}_{t}^{i n} ,$$

of a previously determined word, [symbol] ₜ₋₁, is input to the transformer 202 along with a hidden state, (hₜ₋₁) to attempt to generate the word, [symbol] ₜ. The transformer 202 processes the inputs and then outputs a vector representation,

$${x}_{t}^{o u t} ,$$

of a next word, [symbol] ₜ. The output vector representation,

$${x}_{t}^{o u t} ,$$

is processed, for example in the embodiment of FIG. 2, using Softmax to determine a probability (e.g., entropy) of the determined next word next word, [symbol] ₜ. In some embodiments, the probability can be determined by the LLM 150. Alternatively or in addition, in some embodiments the probability can be determined by the uncertainty determination module 110, knowing the information regarding a previously determined word and the determined next word.

In the embodiment of FIG. 2, the uncertainty determination module 110 monitors the output of the transformer 202 and determines an uncertainty measure associated with the output (e.g., word/token) of the transformer 202. In the embodiment of FIG. 2, the uncertainty determination module 110 monitors the output of the transformer 202 to determine an entropy measure. Although in the embodiment of FIG. 2, the uncertainty measure is described as an entropy measure, alternatively or in addition, in some embodiments the uncertainty measure monitored can include other uncertainty measures, such as an measure of inconsistency (described in greater detail below). In some embodiments of the present principles, such as the embodiment of FIG. 2, the uncertainty/entropy measure (e.g., determined by the uncertainty determination module 110) can be communicated to the think token generation module 120 of the reasoning system 100 of FIG. 1.

In the embodiment of FIG. 2, the think token generation module 120 can generate a think token based on the uncertainty/entropy measure received from the uncertainty determination module 110. In some embodiments, the generated think token, when implemented by the LLM 150, causes the LLM 150 to pause from a normal routine of generating tokens and to perform at least one additional computation for attempting to generate a current word/token before generating responses; improving complex problem-solving. For example, in some embodiments of the present principles, the think token generation module 120 can have access to an expected/desired probability (e.g., entropy), which can be represented by a predetermined uncertainty measure threshold (e.g., entropy measure threshold), which for example, can be stored in the storage device 130. In some embodiments, the think token generation module 120 can compare the uncertainty/entropy measure received from the uncertainty determination module 110 to the predetermined entropy measure threshold, and if the received uncertainty/entropy measure does not comply with the predetermined uncertainty/entropy measure threshold, the think token generation module 120 can generate a think token to be communicated to the LLM 150.

For example, in the embodiment of FIG. 2, if the uncertainty/entropy measure determined for the specific word, [symbol] ₜ, being generated by the transformer 202 does not comply with the entropy threshold (e.g., uncertainty/entropy measure is above or, in some cases, below the threshold), the think token generation module 120 can generate a think token and communicate the think token to, for example, the transformer 202 of the LLM 150. As depicted in the embodiment of FIG. 2, upon receiving the think token, the transformer 202 processes at least one additional computation for determining a current word/token. That is, in the embodiment of FIG. 2, upon receiving the think token from the think token generation module 120, the transformer 202 attempts to generate the word/token with now as inputs, a different hidden state, (h), and a different word vector, xₜ₊₁.

Specifically, in the embodiment of FIG. 2 in a “think” column, which depicts an additional computation of the LLM 150 in accordance with the present principles, a word vector, xₜ₊₁, of a word determined in a just previous computation by the transformer 202 is input to the transformer 202 to be used to again determine the word, Wt. In addition, as depicted in FIG. 2, in the additional computation, a hidden layer output of the transformer 202 of a just previous computation by the transformer 202 is input to the transformer 202 to be used to again determine the word, [symbol] ₜ. In the additional computation in the in a “think” column of the embodiment of FIG. 2, the output,

$${x}_{t + 1}^{o u t} ,$$

of the transformer 202 is processed to determine the next word/token, [symbol] ₜ₊₁, which can be the answer to a prompt for the LLM 150.

Although not depicted in the embodiment of FIG. 2, alternatively or in addition, in some embodiments, after the additional computation is performed, the generation of the next word/token, [symbol] ₜ₊₁, can be monitored by the uncertainty determination module 110, as previously described and in accordance with the present principles, to determine if the uncertainty measure associated with generation of the next word/token, [symbol] ₜ₊₁, also does not comply with a predetermined uncertainty measure threshold, and if not, an additional think token can be generated to cause the LLM 150 to again perform at least one additional computation to determine the next word/token. That is, in some embodiments, a second “think” column, as depicted in the embodiment of FIG. 2, can be implemented to enable the LLM 150 to again perform at least one additional computation for attempting to determine the original word/token, [symbol] ₜ.

In some embodiments of the present principles, a probability associated with the determination of a token/word by an LLM, such as the LLM 150 of FIG. 1, can be continuously monitored by a uncertainty determination module of the present principles, such as the uncertainty determination module 110 of FIG. 1, to determine whenever a probability associated with the determination of a token/word does not comply with an uncertainty measure standard/threshold. In such embodiments, a think token can be generated for every instance in which an uncertainty measure does not comply with an expected/desired probability as depicted by a measure of uncertainty.

In some embodiments of the present principles, the embodiment of FIG. 2 can depict the training of an LLM, such as the LLM 150 of FIG. 1. That is, in the embodiment of FIG. 2, the LLM 150 can be determining tokens in response to training data. During training, as previously recited, the generation of tokens is again monitored by the uncertainty determination module 110 and a respective measure of uncertainty is determined for the generation of each token. The respective measures of uncertainty are communicated to the think token generation module 120 at which, if a respective determined measure of uncertainty does not comply with a standard (e.g., a predetermined threshold), a think token is generated for the LLM 150. That is, in such embodiments, the LLM 150 is trained to use think tokens whenever processing a difficult/complex question/problem, which results in a measure of uncertainty that does not comply with a standard (e.g., a predetermined threshold).

As recited above, in some embodiments an uncertainty measure of the present principles can include a measure of inconsistency. That is, hallucinations occur when there is a contradiction/inconsistency between a statement A from an LLM and another statement B that otherwise should be consistent. In accordance with embodiments of the present principles, in some embodiments the uncertainty determination module 110 can monitor the outputs of a language model, such as the LLM 150 of FIG. 1, to determine if any inconsistency exist in the outputs. For example, in some embodiments, the uncertainty determination module 110 can evaluate responses of the LLM to the same or semantically equivalent prompts, and, in some embodiments, can look for variations in output, and assess adherence to criteria like transitivity, asymmetry, and independence from irrelevant alternatives. For example, transitivity indicates that if an LLM prefers A to B and B to C, it should also prefer A to C (transitivity). Asymmetry indicates that if an LLM prefers A to B, it should not also prefer B to A (asymmetry). In IIA, an LLM's preference between A and B should not be affected by the presence or absence of a third option (IIA).

In some embodiments of the present principles, the uncertainty determination module 110 can determine a measure of uncertainty based on a conceptual consistency determined for a language model, such as the LLM 150 of FIG. 1. That is in some embodiments, a conceptual consistency can be measured for a language model by prompting a language model in order to extract background knowledge facts to background queries and anchor tasks, comparing known background knowledge facts for a given anchor task associated with known answers with the extracted language model background knowledge facts to determine a model performance, determining a background knowledge score and an anchor task score based on the language model's performance, and determining a conceptual consistency score for the language model by predicting the anchor task score from the background knowledge score. The determination module 110 can then determine a measure of uncertainty based on the conceptual consistency score determined for the language model. The process of determining a conceptual consistency score is described in commonly-owned U.S. patent application Ser. No. 18/541,035, filed Dec. 15, 2023, which is herein incorporated by reference in its entirety.

As previously described, in such embodiments, the uncertainty determination module 110 can determine a measure of uncertainty based on consistencies/inconsistencies detected in the determined tokens/words of the LLM 150. For example, in some embodiments the uncertainty determination module 110 can determine a percentage of inconsistency between tokens/words determined by the LLM 150 from prompts that are equivalent and should generate consistent tokens/words. In accordance with the present principles, such measure of uncertainty determined by the uncertainty determination module 110 can be communicated to the think token generation module 120. As described above with reference to FIG. 2 and the measure of entropy, similarly the measure of inconsistency can be compared to, for example, expected/desired inconsistency measures, which can include a predetermined threshold of inconsistencies, that can be stored in the storage device 130, and if the measure of the monitored inconsistencies does not comply with the expected/desired inconsistency measures, the think token generation module 120 can generate a think token. Alternatively or in addition, in some embodiments the uncertainty determination module can make a determination that the LLM 150 is either consistent or not consistent in determining tokens, and such information can be communicated to the think token generation module 120. In such embodiments, based on whether or not the LLM 150 is determined to be consistent, the think token generation module 120 can generate a think token. The generated think token can be communicated to the LLM 150 to cause the LLM 150 to perform at least one additional computation for determining the token to attempt to increase consistency of the LLM 150.

Although in the description of a reasoning system of the present principles above, the generation of a single think token is described as causing a single additional computation by a language model, in alternate embodiments of the present principle, the generation of a single think token can cause more than one additional computation by a language model. In addition, in some embodiments of the present principles, it would take the generation of more than one think token to cause a single additional computation by a language model. Even further, in some embodiments of the present principles, any combination of think tokens can cause any number of additional computations by a language model based on design.

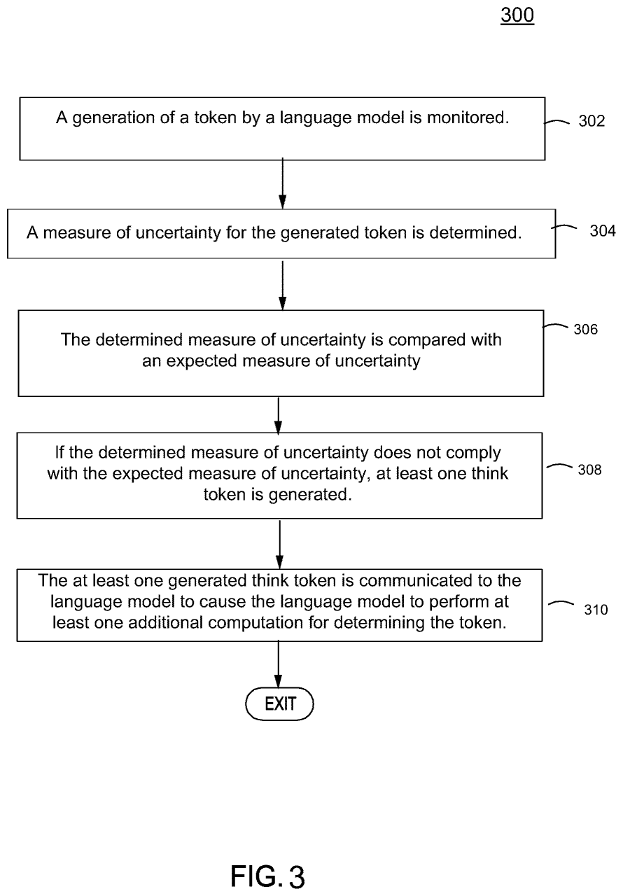

FIG. 3 depicts a flow diagram of a method 300 for preventing hallucinations in a language model. The method 300 of FIG. 3 can begin at 302 during which a generation of a token by the language model is monitored. The method 300 can proceed to 304.

At 304, a measure of uncertainty for the generated token is determined. The method 300 can proceed to 306.

At 306, the determined measure of uncertainty is compared with an expected measure of uncertainty. The method 300 can proceed to 308.

At 308, if the determined measure of uncertainty does not comply with the expected measure of uncertainty, at least one think token is generated. The method 300 can proceed to 310.

At 310, the generated at least one think token is communicated to the language model to cause the language model to perform at least one additional computation for determining the token. The method 300 can be exited.

In some embodiments, the token is at least one word in a series of words.

In some embodiments, the measure of uncertainty is a measure of entropy.

In some embodiments, the measure of uncertainty is a measure of inconsistency.

In some embodiments, the at least one additional computation comprises a tokenization computation using the just previously determined token and a just previously implemented hidden state.

In some embodiments, the method further includes monitoring the token generated by the at least one additional computation, determining a measure of uncertainty for the token generated by the at least one additional computation, comparing the measure of uncertainty determined for the token generated by the at least one additional computation with an expected measure of uncertainty, generating at least one other think token if the measure of uncertainty determined for the token generated by the at least one additional computation does not comply with the expected measure of uncertainty, and communicating the at least one generated other think token to the language model to cause the language to perform at least one other additional computation for determining the token.

In some embodiments, the expected measure of uncertainty comprises a predetermined threshold value of uncertainty.

In some embodiments, the monitored, generated token comprises at least one of a portion of a word, a word, a phrase, a portion of an image, an image, a portion of a video, or a video.

In some embodiments, the language model is trained to perform at least one additional computation every time the token is being generated based on at least one respective, generated think token.

In some embodiments an apparatus for preventing hallucinations in a language model includes a processor and a memory coupled to the processor, the memory having stored therein at least one of programs or instructions. In some embodiments, when the processor executes the programs or instructions, the apparatus is configured to monitor a generation of a token by the language model, determine a measure of uncertainty for the generated token, compare the determined measure of uncertainty with an expected measure of uncertainty, generate at least one think token if the determined measure of uncertainty does not comply with the expected measure of uncertainty, and communicate the generated at least one think token to the language model to cause the language model to perform at least one additional computation for determining the token.

In some embodiments a system for preventing hallucinations in a language model includes a language model and an apparatus including a processor and a memory coupled to the processor, the memory having stored therein at least one of programs or instructions. In some embodiments, when the processor executes the programs or instructions, the apparatus is configured to monitor a generation of a token by the language model, determine a measure of uncertainty for the generated token, compare the determined measure of uncertainty with an expected measure of uncertainty, generate at least one think token if the determined measure of uncertainty does not comply with the expected measure of uncertainty, and communicate the at least one generated think token to the language model to cause the language model to perform at least one additional computation for determining the token.

As depicted in FIG. 1, embodiments of a reasoning system of the present principles, such as the reasoning system 100 of FIG. 1, can be implemented in a computing device 400 in accordance with the present principles. That is, in some embodiments, multimodal content, questions regarding the multimodal content, data and the like can be communicated to components of the reasoning system 100 of FIG. 1 using the computing device 400 via, for example, any input/output means associated with the computing device 400. Data associated with a reasoning system in accordance with the present principles can be presented to a user using an output device of the computing device 400, such as a display, a printer or any other form of output device.

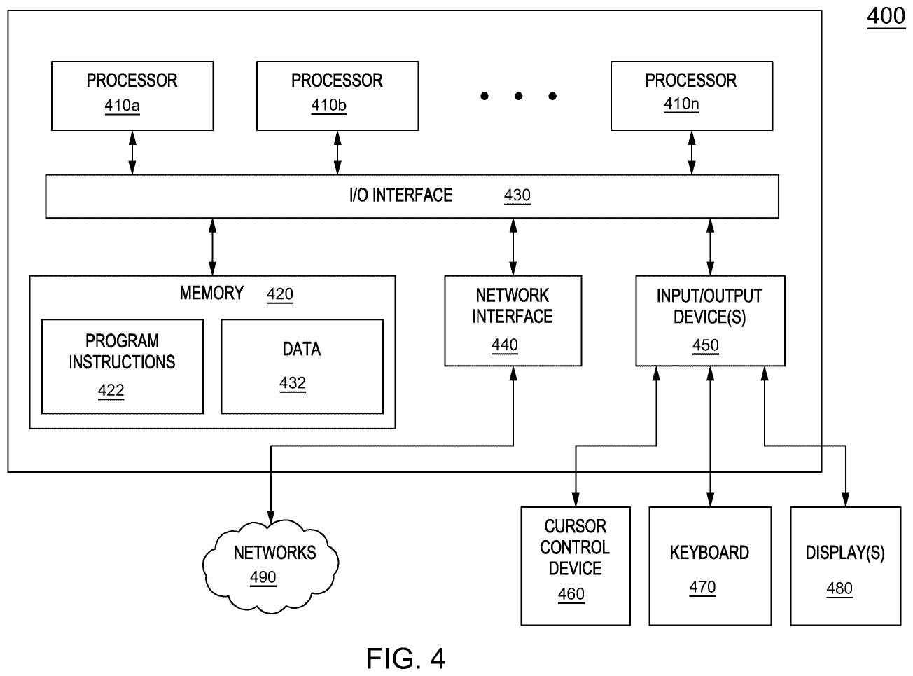

For example, FIG. 4 depicts a high-level block diagram of a computing device 400 suitable for use with embodiments of a reasoning system in accordance with the present principles such as the reasoning system 100 of FIG. 1. In some embodiments, the computing device 400 can be configured to implement methods of the present principles as processor-executable executable program instructions 422 (e.g., program instructions executable by processor(s) 410) in various embodiments.

In the embodiment of FIG. 4, the computing device 400 includes one or more processors 410a-410n coupled to a system memory 420 via an input/output (I/O) interface 430. The computing device 400 further includes a network interface 440 coupled to I/O interface 430, and one or more input/output devices 450, such as cursor control device 460, keyboard 470, and display(s) 480. In various embodiments, a user interface can be generated and displayed on display 480. In some cases, it is contemplated that embodiments can be implemented using a single instance of computing device 400, while in other embodiments multiple such systems, or multiple nodes making up the computing device 400, can be configured to host different portions or instances of various embodiments. For example, in one embodiment some elements can be implemented via one or more nodes of the computing device 400 that are distinct from those nodes implementing other elements. In another example, multiple nodes may implement the computing device 400 in a distributed manner.

In different embodiments, the computing device 400 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 400 can be a uniprocessor system including one processor 410, or a multiprocessor system including several processors 410 (e.g., two, four, eight, or another suitable number). Processors 410 can be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 can be configured to store program instructions 422 and/or data 432 accessible by processor 410. In various embodiments, system memory 420 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 420. In other embodiments, program instructions and/or data can be received, sent or stored upon different types of computer-accessible media or on similar media separate from system memory 420 or computing device 400.

In one embodiment, I/O interface 430 can be configured to coordinate I/O traffic between processor 410, system memory 420, and any peripheral devices in the device, including network interface 440 or other peripheral interfaces, such as input/output devices 450. In some embodiments, I/O interface 430 can perform any necessary protocol, timing or other data transformations to convert data signals from one component (e.g., system memory 420) into a format suitable for use by another component (e.g., processor 410). In some embodiments, I/O interface 430 can include support for devices attached through various types of peripheral buses, such as a variant of the Peripheral Component Interconnect (PCI) bus standard or the Universal Serial Bus (USB) standard, for example. In some embodiments, the function of I/O interface 430 can be split into two or more separate components, such as a north bridge and a south bridge, for example. Also, in some embodiments some or all of the functionality of I/O interface 430, such as an interface to system memory 420, can be incorporated directly into processor 410.

Network interface 440 can be configured to allow data to be exchanged between the computing device 400 and other devices attached to a network (e.g., network 490), such as one or more external systems or between nodes of the computing device 400. In various embodiments, network 490 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 450 can, in some embodiments, include one or more display terminals, keyboards, keypads, touchpads, scanning devices, voice or optical recognition devices, or any other devices suitable for entering or accessing data by one or more computer systems. Multiple input/output devices 450 can be present in computer system or can be distributed on various nodes of the computing device 400. In some embodiments, similar input/output devices can be separate from the computing device 400 and can interact with one or more nodes of the computing device 400 through a wired or wireless connection, such as over network interface 440.

Those skilled in the art will appreciate that the computing device 400 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 400 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 400 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 600 can further include a web browser.

Although the computing device 400 is depicted as a general purpose computer, the computing device 400 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

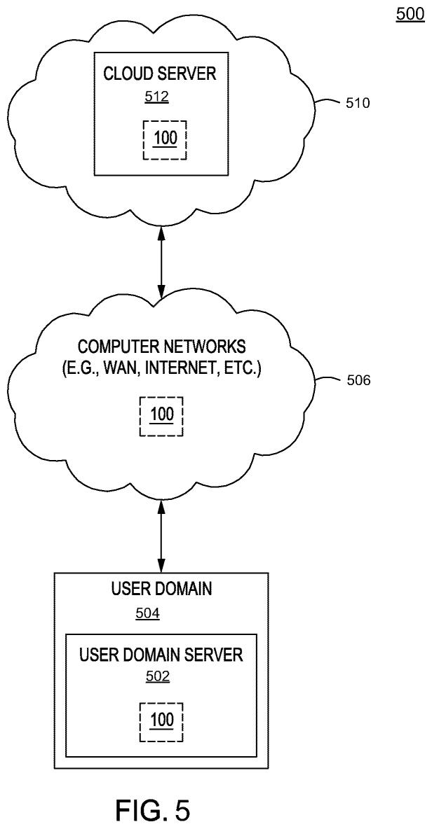

FIG. 5 depicts a high-level block diagram of a network in which embodiments of a reasoning system in accordance with the present principles, such as the reasoning system 100 of FIG. 1, can be applied. The network environment 500 of FIG. 5 illustratively comprises a user domain 502 including a user domain server/computing device 504. The network environment 500 of FIG. 5 further comprises computer networks 506, and a cloud environment 510 including a cloud server/computing device 512.

In the network environment 500 of FIG. 5, a system for reasoning in accordance with the present principles, such as the system 100 of FIG. 1, can be included in at least one of the user domain server/computing device 504, the computer networks 506, and the cloud server/computing device 512. That is, in some embodiments, a user can use a local server/computing device (e.g., the user domain server/computing device 504) to provide the functionalities of a reasoning system in accordance with the present principles.

In some embodiments, a user can implement a system for reasoning in the computer networks 506 to prevent hallucinations in a language model in accordance with the present principles. Alternatively or in addition, in some embodiments, a user can implement a system for reasoning in the cloud server/computing device 512 of the cloud environment 510 to prevent hallucinations in a language model in accordance with the present principles. For example, in some embodiments it can be advantageous to perform processing functions of the present principles in the cloud environment 510 to take advantage of the processing capabilities and storage capabilities of the cloud environment 510. In some embodiments in accordance with the present principles, a reasoning system for prevent hallucinations in a language model can be located in a single and/or multiple locations/servers/computers to perform all or portions of the herein described functionalities of a reasoning system in accordance with the present principles. For example, in some embodiments some components of a reasoning system of the present principles can be located in one or more than one of the a user domain 502, the computer network environment 506, and the cloud environment 510 while other components of the present principles can be located in at least one of the user domain 502, the computer network environment 506, and the cloud environment 510 for providing the functions described above either locally or remotely.

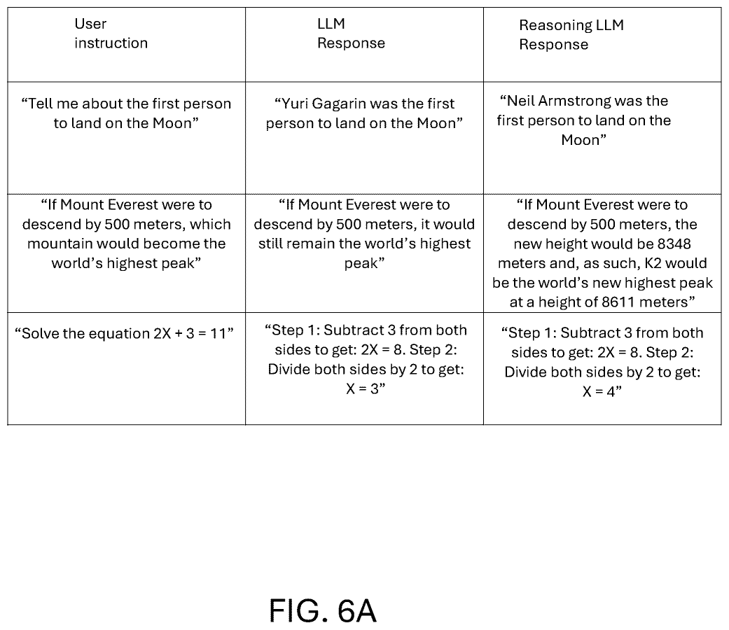

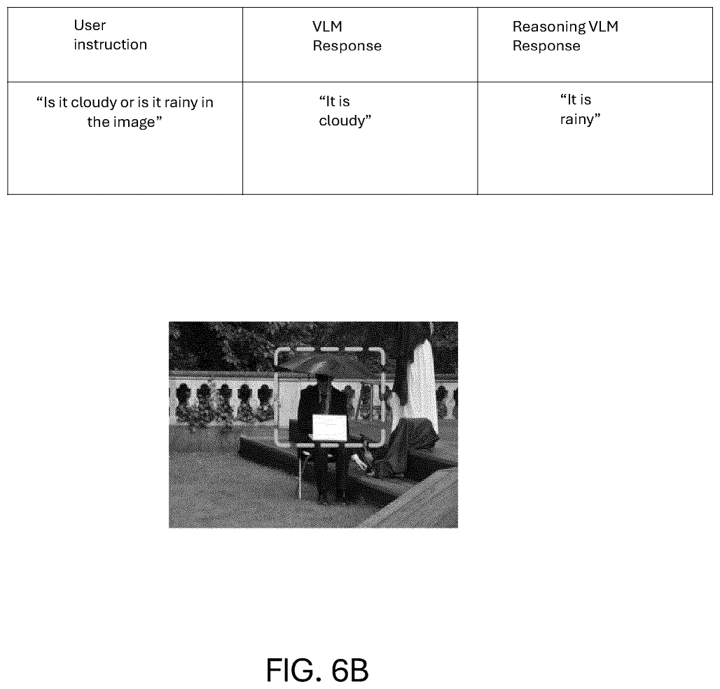

FIG. 6A depicts a Table displaying the effects to the output of text content of an LLM in an experiment in which a reasoning system of the present principles, such as the reasoning system 100 of FIG. 1, is applied. As depicted in FIG. 6A, in response to a user instruction of “Tell me about the first person to land on the Moon”, the LLM, without the application of a reasoning system of the present principles, responds “Yuri Gagarin was the first person to land on the Moon”. After the application of a reasoning system of the present principles and specifically after the application of at least one think token to the LLM and at least one additional computation by the LLM, the response to the user instruction by the LLM is “Neil Armstrong was the first person to land on the Moon”. In a second row of the Table of FIG. 6A, in response to a user instruction of “If Mount Everest were to descend by 500 meters, which mountain would become the world's highest peak”, the LLM, without the application of a reasoning system of the present principles, responds “If Mount Everest were to descend by 500 meters, it would still remain the world's highest peak”. After the application of a reasoning system of the present principles and specifically after the application of at least one think token to the LLM and at least one additional computation by the LLM, the response to the user instruction by the LLM is “If Mount Everest were to descend by 500 meters, the new height would be 8348 meters and, as such, K2 would be the world's new highest peak at a height of 8611 meters”. In a third row of the Table of FIG. 6A, in response to a user instruction of “Solve the equation 2X+3=11”, the LLM, without the application of a reasoning system of the present principles, responds “Step 1: Subtract 3 from both sides to get: 2X=8. Step 2: Divide both sides by 2 to get: X=3”. After the application of a reasoning system of the present principles and specifically after the application of a think token to the LLM and an additional computation by the LLM, the response to the user instruction by the LLM is “Step 1: Subtract 3 from both sides to get: 2X=8. Step 2: Divide both sides by 2 to get: X=4”. As depicted by the examples of the Table of FIG. 6A, after the application of a reasoning system of the present principles and specifically after the application of a think token to the LLM and an additional computation by the LLM, hallucinations (incorrect responses) of the LLM are eliminated.

FIG. 6B depicts a Table displaying the effects to the output of image content of a VLM in an experiment in which a reasoning system of the present principles, such as the reasoning system 100 of FIG. 1, is applied. FIG. 6B further depicts an image of a man with an umbrella sitting in the rain. As depicted in FIG. 6B, in response to a user instruction, with respect to an image, of “Is it cloudy or is it rainy in the image”, the VLM, without the application of a reasoning system of the present principles, responds “It is cloudy”. After the application of a reasoning system of the present principles and specifically after the application of at least one think token to the VLM and at least one additional computation by the VLM, the response to the user instruction by the VLM is “It is rainy”.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 400 can be transmitted to the computing device 400 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for preventing hallucinations in a language model, comprising:
monitoring a generation of a token by the language model;
determining a measure of uncertainty for the generated token:
comparing the determined measure of uncertainty with an expected measure of uncertainty;
generating at least one think token if the determined measure of uncertainty does not comply with the expected measure of uncertainty; and
communicating the at least one generated think token to the language model to cause the language model to perform at least one additional computation for determining the token.

2. The method of claim 1, further comprising:
monitoring the token generated by the at least one additional computation;
determining a measure of uncertainty for the token generated by the at least one additional computation;
comparing the measure of uncertainty determined for the token generated by the at least one additional computation with an expected measure of uncertainty;
generating at least one other think token if the measure of uncertainty determined for the token generated by the at least one additional computation does not comply with the expected measure of uncertainty; and
communicating the at least one generated other think token to the language model to cause the language to perform at least one other additional computation for determining the token.

3. The method of claim 1, wherein the measure of uncertainty is at least one of a measure of entropy or a measure of inconsistency.

4. The method of claim 1, wherein the expected measure of uncertainty comprises a predetermined threshold value of uncertainty.

5. The method of claim 1, wherein the at least one additional computation comprises a tokenization computation using the just previously determined token and a just previously implemented hidden state.

6. The method of claim 1, wherein the monitored, generated token comprises at least one of a portion of a word, a word, a phrase, a portion of an image, an image, a portion of a video, or a video.

7. The method of claim 1, wherein the language model is trained to perform at least one additional computation every time the token is being generated based on at least one respective, generated think token.

8. An apparatus for preventing hallucinations in a language model, comprising:
a processor; and
a memory coupled to the processor, the memory having stored therein at least one of programs or instructions executable by the processor to configure the apparatus to:
monitor a generation of a token by the language model;
determine a measure of uncertainty for the generated token:
compare the determined measure of uncertainty with an expected measure of uncertainty;
generate at least one think token if the determined measure of uncertainty does not comply with the expected measure of uncertainty; and
communicate the at least one generated think token to the language model to cause the language model to perform at least one additional computation for determining the token.

9. The apparatus of claim 1, wherein the apparatus is further configured to:
monitor the token generated by the at least one additional computation;
determine a measure of uncertainty for the token generated by the at least one additional computation;
compare the measure of uncertainty determined for the token generated by the at least one additional computation with an expected measure of uncertainty;
generate at least one other think token if the measure of uncertainty determined for the token generated by the at least one additional computation does not comply with the expected measure of uncertainty; and
communicate the at least one generated other think token to the language model to cause the language to perform at least one other additional computation for determining the token.

10. The apparatus of claim 1, wherein the measure of uncertainty is at least one of a measure of entropy or a measure of inconsistency.

11. The apparatus of claim 1, wherein the expected measure of uncertainty comprises a predetermined threshold value of uncertainty.

12. The apparatus of claim 1, wherein the at least one additional computation comprises a tokenization computation using the just previously determined token and a just previously implemented hidden state.

13. The apparatus of claim 1, wherein the monitored, generated token comprises at least one of a portion of a word, a word, a phrase, a portion of an image, an image, a portion of a video, or a video.

14. The apparatus of claim 1, wherein the language model is trained to perform at least one additional computation every time the token is being generated based on at least one respective, generated think token.

15. A system for preventing hallucinations in a language model, comprising:
a language model; and
an apparatus comprising a processor and a memory coupled to the processor, the memory having stored therein at least one of programs or instructions executable by the processor to configure the system to:
monitor a generation of a token by the language model;
determine a measure of uncertainty for the generated token:
compare the determined measure of uncertainty with a predetermined threshold;
generate a think token if the determined measure of uncertainty does not comply with the predetermined threshold; and
communicate the generated think token to the language model to cause the language model to perform at least one additional computation for determining the token.

16. The system of claim 15, wherein the system is further configured to:
monitor the token generated by the at least one additional computation;
determine a measure of uncertainty for the token generated by the at least one additional computation;
compare the measure of uncertainty determined for the token generated by the at least one additional computation with an expected measure of uncertainty;
generate at least one other think token if the measure of uncertainty determined for the token generated by the at least one additional computation does not comply with the expected measure of uncertainty; and
communicate the at least one generated other think token to the language model to cause the language to perform at least one other additional computation for determining the token.

17. The system of claim 15, wherein the measure of uncertainty is at least one of a measure of entropy or a measure of inconsistency.

18. The system of claim 15, wherein the at least one additional computation comprises a tokenization computation using the just previously determined token and a just previously implemented hidden state.

19. The system of claim 15, wherein the language model is trained to perform at least one additional computation every time the token is being generated based on at least one respective, generated think token.

20. The system of claim 15, wherein the language model comprises a large language model.
